(19) United States
(12) Patent Application Publication
(10) Pub. No.: US 2025/0059362 A1
(43) Pub. Date: Feb. 20, 2025

(54) SOFT POLYOLEFIN COMPOSITION

(71) Applicant: Basell Poliolefine Italia S.r.l., Milano (IT)

(72) Inventors: Michele Grazzi, Ferrara (IT); Monica Galvan, Ferrara (IT)

(73) Assignee: Basell Poliolefine Italia S.r.l., Milano (IT)

(21) Appl. No.: 18/720,986

(22) PCT Filed: Dec. 12, 2022
(86) PCT No.: PCT/EP2022/085289

§ 371 Date: Jun. 17, 2024

(30) Foreign Application Priority Data
Dec. 23, 2021 (EP) 21217233.2

(51) Int. Cl. C08L 23/14; C08L 23/20

(52) U.S. Cl. CPC C08L 23/14; C08L 23/20; C08L 2203/16; C08L 2205/025; C08L 2205/03

(57) ABSTRACT

A polyolefin composition made from or containing

(I) 75-95 wt % of a thermoplastic polyolefin made from or containing

(A) 18-30 wt % of a propylene copolymer with 1.0-6.0 wt. % of CH₂═CHR comonomer, having a melt flow rate (MFR) ranging from 30 to 60 g/10 min; and

(B) 70-82 wt % of a propylene copolymer with 20-35 wt. % of CH₂═CHR comonomer, and optionally a diene,

wherein the thermoplastic polyolefin has

i) a xylene soluble fraction equal to or greater than 70 wt. %; and

ii) a MFR from 0.2 to 15.0 g/10 min, and

(II) 5-25 wt % of a polybutene component,

having a flexural modulus equal to or lower than 60 MPa and

made from or containing a butene-1 copolymer with ethylene and optionally a comonomer of formula CH₂═CHR¹, wherein the copolymer having

i) up to and including 20 wt % of ethylene-or comonomer-derived units; and

ii) Mw/Mn equal to or lower than 3.

### FIELD OF THE INVENTION

In general, the present disclosure relates to the field of chemistry. More specifically, the present disclosure relates to polymer chemistry. In particular, the present disclosure relates to a thermoplastic polyolefin compositions and films or sheets made therefrom.

### BACKGROUND OF THE INVENTION

In some instances, elastomers and thermoplastic polyolefins are used to produce sheets and membranes for use as geomembranes or in roofing applications.

Polyvinyl chloride (PVC) and other chlorinated thermoplastic polyolefins (TPOs) were used to prepare heat-weldable thermoplastic roofing sheets. However, PVC used plasticizers to provide flexibility for roofing applications. The aging of membranes through the loss of plasticizers and the presence of chlorine in the polymer chains were the drivers for the substitution of PVC with chlorine-free thermoplastic polyolefins, which provided mechanical properties in absence of plasticizers.

In some instances, thermoplastic polyolefins are used to prepare sheets or membranes for roofing applications, providing that the TPOS are flexible, heat-weldable, and recyclable.

### SUMMARY OF THE INVENTION

In a general embodiment, the present disclosure provides a polyolefin composition made from or containing:
(I) 75-95% by weight of a thermoplastic polyolefin made from or containing
   (A) 18-30% by weight of a copolymer of propylene with from 1.0 to 6.0% by weight of a comonomer of formula CH₂═CHR, where R is H or a linear or branched C2-C8 alkyl, based on the weight of (A), and having a melt flow rate (MFR(A)), measured according to ISO 1133 (230° C., 2.16 kg), ranging from 30 to 60 g/10 min; and
   (B) 70-82% by weight of a copolymer of propylene with from 20 to 35% by weight of a comonomer of formula CH₂═CHR, and optionally a diene, where R is H or a linear or branched C2-C8 alkyl, based on the weight of (B),
   wherein the thermoplastic polyolefin has
      i) an amount of fraction soluble in xylene at 25° C. (XS(I)) equal to or greater than 70% by weight, based on the total weight of (A)+(B), and
      ii) a melt flow rate (MFR(I)), measured according to ISO 1133 (230° C., 2.16 kg), from 0.2 to 15.0 g/10 min, and
   wherein the amounts of (A) and (B) are based on the total weight of (A)+(B); and
(II) 5-25% by weight of a polybutene component,
having a flexural modulus equal to or lower than 60 MPa, measured according to the method ISO 178:2019, and
made from or containing a copolymer of butene-1 with ethylene and optionally a comonomer of formula CH₂═CHR¹, where R¹ is methyl or a linear or branched C3-C8 alkyl, wherein the copolymer of butene-1 having
   i) up to and including 20% by weight of units deriving from ethylene and optionally the comonomer, based on the weight of (II); and
   ii) a molecular weight distribution Mw/Mn equal to or lower than 3;
      wherein the amounts of (I) and (II) are based on the total weight of (I)+(II).
      In some embodiments, the copolymer of butene-1 has i) at least 80% by weight of units deriving from butene-1, based on the weight of (II); and ii) a molecular weight distribution Mw/Mn equal to or lower than 3.

In some embodiments, the present disclosure provides a shaped article made from or containing the polyolefin composition.

In some embodiments, the present disclosure provides sheets or films made from or containing the polyolefin composition. In some embodiments, the present disclosure provides roofing membranes made from or containing the sheets or films.

While multiple embodiments are disclosed, still other embodiments will become apparent to those skilled in the art from the following detailed description.

As will be apparent, certain embodiments, as disclosed herein, are capable of modifications in various aspects, without departing from the spirit and scope of the claims as presented herein. Accordingly, the following detailed description is to be regarded as illustrative in nature and not restrictive.

### DETAILED DESCRIPTION OF THE INVENTION

In the context of the present disclosure;
the percentages are expressed by weight, unless otherwise specified. The total weight of a composition sums up to 100%, unless otherwise specified;
when referred to polymers, the term “blend” refers to reactor-made blends, that is, blends of at least two polymeric components obtained directly from a polymerization process, to mechanical blends, that is, blends obtained by melt-mixing at least two distinct polymeric components, and to combinations thereof;
when the term “comprising” is referred to a polymer or to a polymer composition, mixture or blend, the term should be construed to mean “comprising or consisting essentially of”;
the term “consisting essentially of” means that, in addition to the specified components, the polymer, the polyolefin composition, the mixture, or the blend may be made from or containing other components, provided that the essential characteristics of the polymer, the polymer composition, the mixture, or the blend are not materially affected by the presence of the other components. In some embodiments, the other components are selected from the group consisting of catalyst residues, antistatic agents, melt stabilizers, light stabilizers, antioxidants, and antiacids;
a “film” refers to a thin-layered material, having thickness lower than 5000 μm;
a “sheet” refers to a layer of material, having thickness equal to or greater than 5000 μm.

In some embodiments, the polyolefin composition is made from or containing from 75 to 95% by weight, alternatively from 80 to 90% by weight, alternatively from 80 to less than 90% by weight, alternatively from 82 to 88% by weight, of the thermoplastic polyolefin (I), and from 5 to 25% by weight, alternatively from 10 to 20% by weight, alternatively from more than 10 to 20% by weight, alternatively 12 to 18% by weight, of the polybutene component (II), wherein the amounts of (I) and (II) are based on the total weight of (I)+(II).

In some embodiments, the polyolefin composition has at least one of the following properties:
a melt flow rate (MFR(tot)), measured according to ISO 1133 (230° C., 2.16 kg), ranging from 0.2 to 5.0 g/10 min; or
a mean value of the elongation at break in machine direction (MD) and in transverse direction (TD) equal to or greater than 700%, alternatively ranging from 700 to 900%, determined according to the method ISO 527-3 (Specimens type: 5, Crosshead speed: 500 mm/min) on 1 mm-thick extruded specimens; or
a mean value of the tensile stress at break in machine direction (MD) and in transverse direction (TD) equal to or greater than 15 MPa, alternatively ranging from 15 MPa to 18 MPa, determined according to the method ISO 527-3 (Specimens type: 5, Crosshead speed: 500 mm/min) on 1 mm-thick extruded specimens; or
a Shore A value equal to or lower than 83, measured according to the method ISO 868 (15 sec) on 1 mm-thick extruded specimens; or
a Shore D value equal to or lower than 25, measured according to the method ISO 868 (15 sec) on 1 mm-thick extruded specimens.

In the following, the individual components of the polyolefin composition are defined in more detail. In some embodiments, the components are present in the polyolefin composition in various combinations.

In some embodiments, the thermoplastic polyolefin (I) is made from or containing 20-30% by weight of component (A) and 70-80% by weight of component (B), wherein the amounts of (A) and (B) are based on the total weight of (A)+(B).

In some embodiments, the comonomers CH₂═CHR c of components (A) and (B) of the thermoplastic polyolefin (I) are independently selected from the group consisting of ethylene, butene-1, hexene-1, 4-methy-pentene-1, octene-1, and combinations thereof. In some embodiments, the comonomer is ethylene.

In some embodiments, the thermoplastic polyolefin (I) has an amount of fraction soluble in xylene at 25° C. (XS(I)) equal to or greater than 70% by weight, alternatively ranging from 70 to 90% by weight, alternatively from 70 to 80% by weight, based on the weight of the thermoplastic polyolefin (I).

In some embodiments, the fraction soluble in xylene at 25° C. of the thermoplastic polyolefin (I) has an intrinsic viscosity XSIV(I) ranging from 2.5 to 4.5 dl/g, alternatively from 3.0 to 3.9 dl/g.

In some embodiments, the thermoplastic polyolefin (I) has a melt flow rate MFR(I), measured according to ISO 1133 (230° C., 2.16 kg) ranging from 0.2 to 15.0 g/10 min, alternatively from 0.2 to 5.0 g/10 min, alternatively from 0.3 to 1.5 g/10 min., alternatively from 0.4 to 1.0 g/10 min.

In some embodiments, the value of the melt flow rate MFR(I) is obtained directly from polymerization.

In some embodiments, the value of the melt flow rate MFR(I) is not obtained by degrading (visbreaking) the thermoplastic polyolefin (I) obtained from the polymerization reaction.

In some embodiments, the component (A) is a copolymer of propylene having from 1.0 to 6.0% by weight, alternatively from 2.0 to 4.0% by weight, alternatively from 3.0 to 3.9% by weight, of the comonomer. In some embodiments, the comonomer is ethylene.

In some embodiments, the propylene copolymer (A) has a melt flow rate MFR(A), measured according to ISO 1133 (230° C., 2.16 kg), ranging from 30 to 60 g/10 min., alternatively from 35 to 50 g/10 min., alternatively from 40 to 50 g/10 min., alternatively from 42 to 48 g/10 min.

In some embodiments, the propylene copolymer (A) has a fraction soluble in xylene at 25° C. XS(A) equal to or lower than 9.0% by weight, alternatively ranging from 4.0 to 9.0% by weight, alternatively from 6.0 to 8.0% by weight, wherein the amount of XS(A) is based on the weight of the copolymer (A).

In some embodiments, the propylene copolymer (B) has a fraction soluble in xylene at 25° C. XS(B) equal to or greater than 80% by weight, alternatively equal to or greater than 85% by weight, alternatively equal to or greater than 90% by weight, wherein the amount of XS(B) is based on the weight of the copolymer (B).

In some embodiments, the upper limit of the fraction of component (B) soluble in xylene at 25° C. XS(B) is 97% by weight, based on the weight of the copolymer (B).

In some embodiments, the component (B) is made from or containing a first copolymer (B1) and a second copolymer (B2) of propylene with a comonomer of formula CH₂═CHR, and optionally a diene, where R is H or a linear or branched C2-C8 alkyl, provided that the total amount of comonomer in the propylene copolymer (B) is 20-35% by weight, wherein the total amount of comonomer is based on the weight of component (B).

In some embodiments, component (B) is made from or containing
(B1) 30-60% by weight, alternatively 40-55% by weight, of a first copolymer of propylene with a comonomer of formula CH₂═CHR, and optionally a diene, where R is H or a linear or branched C2-C8 alkyl, having 20-40% by weight, alternatively 25-35% by weight, of units deriving from the comonomer and a fraction soluble in xylene at 25° C. XS(B1) equal to or greater than 80% by weight, alternatively equal to or greater than 85% by weight, alternatively equal to or greater than 90% by weight,

wherein the amount of comonomer and of XS(B1) are based on the weight of component (B1); and
(B2) 40-70% by weight, alternatively 45-60% by weight, of a second copolymer of propylene with a comonomer of formula CH₂═CHR, and optionally a diene, where R is H or a linear or branched C2-C8 alkyl, having 25-45% by weight, alternatively 30-43% by weight, of comonomer and a fraction soluble in xylene at 25° C. (XSB2) equal to or greater than 80% by weight, alternatively equal to or greater than 85% by weight, alternatively equal to or greater than 90% by weight, wherein the amount of comonomer and of XS(B2) are based on the weight of component (B2),
   wherein the amounts of (B1) and (B2) are based on the total weight of the component (B).

In some embodiments, components (B1) and (B2) are different, alternatively have a different comonomer content.

In some embodiments, the upper limit of the fraction of component (B1) soluble in xylene at 25° C. XS (B1), of the fraction of component (B2) soluble in xylene at 25° C. XS(B2), or of both is 97% by weight, wherein the amounts of XS(B1) and XS(B2) are based on the weight of component (B1) and (B2) respectively.

In some embodiments, the propylene copolymer (B) optionally has recurring units derived from a diene. In some embodiments, the diene is selected from the group consisting of butadiene, 1,4-hexadiene, 1,5-hexadiene, ethylidene-1-norbonene, and combinations thereof.

In some embodiments, the total amount of recurring units deriving from a diene in the propylene copolymer (B) ranges from 1 to 10% by weight, with respect to the weight of component (B).

In some embodiments, the thermoplastic polyolefin (I) is made from or containing:
(A) 18-30% by weight, alternatively 20-30% by weight, of a copolymer of propylene with ethylene,
having from 1.0 to 6.0% by weight, alternatively from 2.0 to 4.0% by weight, alternatively from 3.0 to 3.9% by weight, of ethylene, based on the weight of (A), and
having a melt flow rate MFR(A), measured according to ISO 1133 (230° C., 2.16 kg), ranging from 30 to 60 g/10 min., alternatively from 35 to 50 g/10 min., alternatively from 40 to 50 g/10 min., alternatively from 42 to 48 g/10 min; and
(B) 70-82% by weight, alternatively 70-80% by weight, of a copolymer of propylene with ethylene, having 20-35% by weight of ethylene, wherein the amount of ethylene being based on the weight of (B),

wherein the thermoplastic polyolefin has
i) an amount of fraction soluble in xylene at 25° C. XS(I) equal to or greater than 70% by weight, alternatively ranging from 70 to 90% by weight, alternatively from 70 to 80% by weight, wherein the soluble fraction having an intrinsic viscosity XSIV(I) ranging from 2.5 to 4.5 dl/g, alternatively from 3.0 to 3.9 dl/g; and
ii) a melt flow rate MFR(I), measured according to ISO 1133, 230° C., 2.16 kg, from 0.2 to 2.0 g/10 min., alternatively from 0.3 to 1.5 g/10 min., alternatively from 0.4 to 1.0 g/10 min.,

wherein the amounts of (A), (B) and of the fraction soluble in xylene at 25° C. XS(I) are based on the total weight of (A)+(B). In some embodiments, MFR(I) is obtained directly from polymerization.

In some embodiments, the thermoplastic polyolefin (I) has at least one of the following properties:
a flexural modulus ranging from 40 to 90 MPa, alternatively from 50 to 80 MPa, alternatively from 50 to 70 MPa, wherein the flexural modulus is measured according to ISO 178:2019 on injection molded specimens; or
a tensile modulus in MD, TD, or both, determined according to the method ISO 527-3 (specimens type 2, Crosshead speed: 1 mm/min) on 1 mm-thick extruded specimens, in the range 30-70 MPa; or
a stress at break in MD, TD, or both, determined according to the method ISO 527-3 (Specimens type: 5, Crosshead speed: 500 mm/min) on 1 mm-thick extruded specimens, in the range 10.0-20.0 MPa, alternatively 13.0-18.0 MPa; or
an elongation at break in MD, TD, or both, determined according to the method ISO 527-3 (Specimens type: 5, Crosshead speed: 500 mm/min) on 1 mm-thick extruded specimens, in the range 600-800%; or
a tear resistance in MD, TD, or both, determined according to the method ASTM D 1004 (Crosshead speed: 51 mm/min; V-shaped die cut specimen) on 1 mm-thick extruded specimens, in the range 40-70 g, alternatively 40-60 g; or
a shore A value, determined according to the method ISO 868 (15 sec) on 1 mm-thick extruded specimens, in the range 70-90; or
a shore D value equal to or lower than 30, measured on 1 mm-thick extruded specimens according to method ISO 868 (15 sec). In some embodiments, the Shore D value is in the range 23-30.

In some embodiments, the thermoplastic polyolefin (I) is a mechanical blend, alternatively a reactor blend, of components (A) and (B). In some embodiments, the reactor blend is prepared by a sequential polymerization process in at least two stages, wherein the second and each subsequent polymerization stage is carried out in the presence of the polymer produced and the catalyst used in the immediately preceding polymerization stage.

In some embodiments, the polymerization processes to prepare the single components (A) and (B) or the sequential polymerization process to prepare the reactor blend of (A) and (B) are carried out in the presence of a catalyst selected from the group consisting of metallocene compounds, stereospecific Ziegler-Natta catalyst systems, and combinations thereof.

In some embodiments, the polymerization process to prepare the single components (A) and (B) or the sequential polymerization process are carried out in the presence of a stereospecific Ziegler-Natta catalyst system made from or containing:
(1) a solid catalyst component made from or containing a magnesium halide support on which a Ti compound, having a Ti-halogen bond is present, and a stereoregulating internal donor;
(2) optionally, an Al-containing cocatalyst; and
(3) optionally, a further electron-donor compound (external donor).

In some embodiments, the solid catalyst component (1) is made from or containing a titanium compound of formula Ti(OR)ₙX_{y_n}, wherein n is between 0 and y; y is the valence of titanium; X is halogen; and R is a hydrocarbon group having 1-10 carbon atoms or a —COR group. In some embodiments, titanium compounds, having a Ti-halogen bond, are selected from the group consisting of titanium tetrahalides and titanium halogenalcoholates. In some embodiments, the titanium compounds are selected from the group consisting of TiCl₃, TiCl₄, Ti(OBu)₄, Ti(OBu)Cl₃, Ti(OBu)₂Cl₂, and Ti(OBu)₃Cl. In some embodiments, the titanium compounds are TiCl₄.

In some embodiments, the solid catalyst component (1) is made from or containing a titanium compound in an amount providing from 0.5 to 10% by weight of Ti with respect to the total weight of the solid catalyst component (1).

In some embodiments, the solid catalyst component (1) is made from or containing a stereoregulating internal donor selected from mono or bidentate organic Lewis bases. In some embodiments, the solid catalyst component (1) is made from or containing a stereoregulating internal electron donor compound selected from the group consisting of esters, ketones, amines, amides, carbamates, carbonates, ethers, nitriles, alkoxysilanes, and combinations thereof.

In some embodiments, the electron donors are selected from the group consisting of aliphatic or aromatic mono-or dicarboxylic acid esters and diethers.

In some embodiments, the alkyl and aryl esters of optionally substituted aromatic polycarboxylic acids are selected from the group consisting of esters of phthalic acids. In some embodiments, the esters of phthalic acids are as described in European Patent Application Nos. EP 45977A2 and EP395083A2.

In some embodiments, the internal electron donor is selected from the group consisting of mono- or di-substituted phthalates, wherein the substituents are independently selected from the group consisting of linear or branched C₁₋₁₀ alkyl, C₃₋₈ cycloalkyl, and aryl radical.

In some embodiments, the internal electron donor is selected from the group consisting of di-isobutyl phthalate, di-n-butyl phthalate, di-n-octyl phthalate, diphenyl phthalate, benzylbutyl phthalate, and combinations thereof. In some embodiments, the internal electron donor is di-isobutyl phthalate.

In some embodiments, the esters of aliphatic acids are selected from the group consisting of esters of malonic acids, esters of glutaric acids, and esters of succinic acids. In some embodiments, the esters of malonic acids are as described in Patent Cooperation Treaty Publication Nos. WO98/056830, WO98/056833, and WO98/056834. In some embodiments, the esters of glutaric acids are as described in Patent Cooperation Treaty Publication No. WO00/55215. In some embodiments, the esters of succinic acids are as described in Patent Cooperation Treaty Publication No. WO00/63261.

In some embodiments, the diesters are derived from esterification of aliphatic or aromatic diols. In some embodiments, the diesters are as described in Patent Cooperation Treaty Publication No. WO2010/078494 and U.S. Pat. No. 7,388,061.

In some embodiments, the internal electron donor is selected from 1,3-diethers of formula

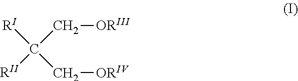

wherein R^{I} and R^{II} are independently selected from C₁₋₁₈ alkyl, C₃₋₁₈ cycloalkyl, and C₇₋₁₈ aryl radicals, R^{III} and R^{IV} are independently selected from C₁₋₄ alkyl radicals; or the carbon atom in position 2 of the 1,3-diether belongs to a cyclic or polycyclic structure made up of from 5 to 7 carbon atoms, or of 5-n or 6-n′ carbon atoms, and respectively n nitrogen atoms and n′ heteroatoms selected from the group consisting of N, O, S, and Si, where n is 1 or 2 and n′is 1, 2, or 3, wherein the structure containing two or three unsaturations (cyclopolyenic structures), and optionally being condensed with other cyclic structures, or substituted with one or more substituents selected from the group consisting of linear or branched alkyl radicals, cycloalkyl, aryl, aralkyl, alkaryl radicals, and halogens, or being condensed with other cyclic structures and substituted with one or more of the substituents selected from the group consisting of linear or branched alkyl radicals, cycloalkyl, aryl, aralkyl, alkaryl radicals, and halogens, wherein one or more of the alkyl, cycloalkyl, aryl, aralkyl, or alkaryl radicals and the condensed cyclic structures optionally contain one or more heteroatom(s) as substitutes for carbon atoms, hydrogen atoms, or both types of atoms. In some embodiments, the substituents are bonded to the condensed cyclic structures. In some embodiments, the ethers are as described in European Patent Application Nos. EP361493 and EP728769 and Patent Cooperation Treaty Publication No. WO02/100904.

In some embodiments, 1,3-diethers are used and the external electron donor (3) is absent.

In some embodiments, mixtures of internal donors are used. In some embodiments, the mixtures are between aliphatic or aromatic mono or dicarboxylic acid esters and 1,3-diethers as described in Patent Cooperation Treaty Publication Nos. WO07/57160 and WO2011/061134.

In some embodiments, the magnesium halide support is magnesium dihalide.

In some embodiments, the amount of internal electron donor, which remains fixed on the solid catalyst component (1), is 5 to 20% by moles, with respect to the magnesium dihalide.

In some embodiments, the preparation of the solid catalyst components involves a reaction of Mg dihalide precursors with titanium chlorides to form the Mg dihalide support. In some embodiments, the reaction is carried out in the presence of the stereoregulating internal donor.

In some embodiments, the magnesium dihalide precursor is a Lewis adduct of formula MgCl₂·nR1OH, where n is a number between 0.1 and 6, and R1 is a hydrocarbon radical having 1-18 carbon atoms. In some embodiments, n ranges from 1 to 5, alternatively from 1.5 to 4.5.

In some embodiments, the adduct is prepared by mixing alcohol and magnesium chloride, operating under stirring conditions at the melting temperature of the adduct (100-130° C.).

Then, the adduct is mixed with an inert hydrocarbon immiscible with the adduct, thereby creating an emulsion which is quickly quenched causing the solidification of the adduct in the form of spherical particles.

In some embodiments, the resulting adduct is directly reacted with the Ti compound or subjected to thermal controlled dealcoholation (80-130° C.), thereby obtaining an adduct wherein the number of moles of alcohol is lower than 3, alternatively between 0.1 and 2.5. In some embodiments, this controlled dealcoholation step is carried out to increase the morphological stability of the catalyst during polymerization or to increase the catalyst porosity as described in European Patent Application No. EP395083A2.

In some embodiments, the reaction with the Ti compound is carried out by suspending the optionally dealcoholated adduct in cold TiCl₄. In some embodiment, cold TiCl₄ is at 0° C. In some embodiments, the mixture is heated up to 80-130° C. and kept at this temperature for 0.5-2 hours. In some embodiments, the treatment with TiCl₄ is carried out one or more times. In some embodiments, the stereoregulating internal donor is added during the treatment with TiCl₄. In some embodiments, the treatment with the internal donor is repeated one or more times.

In some embodiments, the preparation of catalyst components is as described in U.S. Pat. Nos. 4,399,054 and 4,469,648, Patent Cooperation Treaty Publication No. WO98/44009A1, and European Patent Application No. EP395083A2.

In some embodiments, the catalyst component (1) is in the form of spherical particles, having an average diameter ranging from 10 to 350 μm, a surface area ranging from 20 to 250 m²/g, alternatively from 80 to 200 m²/g, and a porosity greater that 0.2 ml/g, alternatively of from 0.25 to 0.5 ml/g, wherein the surface area and the porosity are measured by BET.

In some embodiments, the catalyst system is made from or containing an Al-containing cocatalyst (2). In some embodiments, the Al-containing cocatalyst (2) is selected from the group consisting of Al-trialkyls, alternatively the group consisting of Al-triethyl, Al-triisobutyl, and Al-tri-n-butyl.

In some embodiments, the Al/Ti weight ratio in the catalyst system is from 1 to 1000, alternatively from 20 to 800.

In some embodiments, the catalyst system is further made from or containing electron donor compound (3) (external electron donor). In some embodiments, the external electron donor is selected from the group consisting of silicon compounds, ethers, esters, amines, heterocyclic compounds, and ketones. In some embodiments, the heterocyclic compound is 2,2,6,6-tetramethylpiperidine.

In some embodiments, the external donor is selected from the group consisting of silicon compounds of formula (R2)a(R3)bSi(OR4)c, where a and b are integers from 0 to 2, c is an integer from 1 to 4, and the sum (a+b+c) is 4; R2, R3, and R4 are alkyl, cycloalkyl, or aryl radicals with 1-18 carbon atoms, optionally containing heteroatoms. In some embodiments, a is 1, b is 1, c is 2, at least one of R2 and R3 is selected from branched alkyl, cycloalkyl, or aryl groups with 3-10 carbon atoms, optionally containing heteroatoms, and R4 is a C1-C10 alkyl group. In some embodiments, R4 is a methyl group.

In some embodiments, the silicon compounds are selected from the group consisting of methylcyclohexyldimethoxysilane (C-donor), diphenyldimethoxysilane, methyl-t-butyldimethoxysilane, dicyclopentyldimethoxysilane (D-donor), diisopropyldimethoxysilane, (2-ethylpiperidinyl) t-butyldimethoxysilane, (2-ethylpiperidinyl)thexyldimethoxysilane, (3,3,3-trifluoro-n-propyl) (2-ethylpiperidinyl) dimethoxysilane, methyl(3,3,3-trifluoro-n-propyl)dimethoxysilane, and combinations thereof.

In some embodiments, the silicon compounds are wherein a is 0, c is 3, R3 is a branched alkyl or cycloalkyl group, optionally containing heteroatoms, and R4 is methyl. In some embodiments, the silicon compounds are selected from the group consisting of cyclohexyltrimethoxysilane, t-butyltrimethoxysilane, and hexyltrimethoxysilane.

In some embodiments, the catalyst system is made from or containing di-isobutyl phthalate as internal electron donor and dicyclopentyl dimethoxy silane (D-donor) as external electron donor (3).

In some embodiments, the catalyst system is pre-contacted with small quantities of monomer (prepolymerization), maintaining the catalyst in suspension in a hydrocarbon solvent, and polymerizing at temperatures from 25° to 60° C., thereby producing a quantity of polymer from about 0.5 to about 3 times the weight of the catalyst system.

In some embodiments, the prepolymerization is carried out in liquid monomer, thereby producing a quantity of polymer 1000 times the weight of the catalyst system.

In some embodiments, sequential polymerization processes for preparing the polyolefin compositions are as described in European Patent Application No. EP472946 and Patent Cooperation Treaty Publication No. WO03/011962, which content is incorporated in this patent application.

In some embodiments, the components (A) and (B) are produced in any of the polymerization stages. In some embodiments and in a first copolymerization stage (a), monomers are polymerized to form the propylene copolymer (A), and, in a second copolymerization stage (b), the relevant monomers are polymerized to form the propylene copolymer (B).

In some embodiments, the second copolymerization stage (b) includes a copolymerization stage (b1) and a copolymerization stage (b2), wherein the comonomers are polymerized to form propylene copolymer (B1) and propylene copolymer (B2). In some embodiments, the preparation of propylene copolymer (B1) and propylene copolymer (B2) is not order specific.

In some embodiments, the polymerization process is continuous or batch. In some embodiments, the polymerization process is carried out according to cascade techniques, operating either in mixed liquid phase/gas phase or totally in gas phase.

In some embodiments, the liquid-phase polymerization is carried out in slurry, solution, or bulk (liquid monomer). In some embodiments, the liquid-phase polymerization is carried out in various types of reactors. In some embodiments, the reactors are continuous stirred tank reactors, loop reactors, or plug-flow reactors.

In some embodiments, the gas-phase polymerization is carried out in gas-phase reactors. In some embodiments, the gas-phase reactors are fluidized or stirred, fixed bed reactors.

In some embodiments, the copolymerization stage (a) is carried out in liquid phase using liquid propylene as diluent to form the propylene copolymer (A) and the copolymerization stage (b), or the copolymerization stages (b1) and (b2), are carried out in the gas phase to produce the propylene copolymer (B).

In some embodiments, the copolymerization stage (a) is carried out in the gas phase.

In some embodiments, the reaction temperatures of the polymerization stages (a) and (b) are independently selected from values in the range from 40° to 90° C.

In some embodiments, the polymerization pressure of a copolymerization stage carried out in liquid phase is from 3.3 to 4.3 MPa. In some embodiments, the polymerization pressure of a copolymerization stage carried out in gas-phase is selected from values in the range from 0.5 to 3.0 MPa.

In some embodiments, the residence time of each polymerization stage depends upon the ratio of components (A) and (B) to be achieved. In some embodiments, the residence time in each polymerization stage ranges from 15 minutes to 8 hours.

In some embodiments, the polyolefin composition is a reactor blend, and the amounts of components (A) and (B) correspond to the split between the polymerization reactors.

In some embodiments, the molecular weight of the propylene copolymers obtained in the polymerization stages is regulated using chain transfer agents. In some embodiments, the chain transfer agent is hydrogen or ZnEt₂.

In some embodiments, the thermoplastic polyolefin (I) is further made from or containing up to and including 3.0% by weight, alternatively from 0.01 to 3.0% by weight, of an additive (C) selected from the group consisting of antistatic agents, anti-oxidants, light stabilizers, slipping agents, anti-acids, melt stabilizers, and combinations thereof, wherein the amount of the additive (C) is based on the total weight of the thermoplastic polyolefin (I), the total weight being 100%.

In some embodiments, the thermoplastic polyolefin (I) consists of the components (A), (B), and (C).

In some embodiments, the polybutene component (II) has a flexural modulus equal to or lower than 60 MPa, alternatively equal to or lower than 30 MPa, measured according to the method ISO 178:2019 on compression molded specimens.

In some embodiments, the polybutene component (II) has at least one of the following properties:
a shore A value equal to or lower than 90, alternatively equal to or lower than 70, measured according to the method ISO 868 on compression molded specimens; or
a compression set equal to or lower than 50%, measured on compression molded specimens according to the method ASTM D395 at 23° C. and 25% deformation.

In some embodiments, the polybutene component (II) is made from or containing a copolymer of butene-1 and ethylene having from 5 to 10% by weight of units deriving from ethylene, based on the weight of the polybutene component (II).

In some embodiments, the copolymer of butene-1 has no melting point (TmII) detectable and a melting enthalpy after 10 days of aging (ΔHf) equal to or lower than 25 J/g, alternatively from 4 to 20 J/g, alternatively from 4 to 15 J/g, alternatively from 5 to 10 J/g.

In some embodiments, the polybutene component (II) is made from or containing a copolymer of butene-1, ethylene, and propylene.

In some embodiments, the butene-1 copolymer is obtained by contacting, under polymerization conditions, butene-1, ethylene, and optionally a further comonomer, in the presence of a catalyst system obtainable by contacting:
(1) a stereorigid metallocene compound;
(2) an alumoxane or a compound capable of forming an alkyl metallocene cation; and, optionally,
(3) an organo aluminum compound.

In some embodiments, the stereorigid metallocene compound (1) belongs to the formula (I):

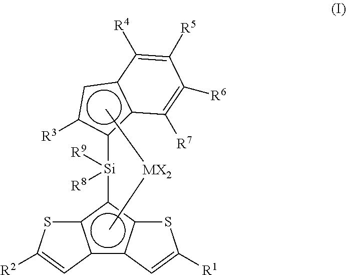

wherein:

M is an atom of a transition metal selected from Group 4 of the Periodic Table of Elements, alternatively M is zirconium;

X, equal to or different from each other, is a hydrogen atom, a halogen atom, a R, OR, OR′O, OSO₂CF₃, OCOR, SR, NR₂, or PR₂ group, wherein R is a linear or branched, saturated or unsaturated C1-C20 alkyl, C3-C20 cycloalkyl, C6-C20 aryl, C7-C20 alkylaryl, or C7-C20 arylalkyl radical, optionally containing heteroatoms belonging to groups 13-17 of the Periodic Table of the Elements; and R′ is a C1-C20 alkylidene, C6-C20 arylidene, C7-C20 alkylarylidene, or C7-C20 arylalkylidene radical;

R¹, R², R⁵, R⁶, R⁷, R⁸, and R⁹, equal to or different from each other, are hydrogen atoms, or linear or branched, saturated or unsaturated C1-C20 alkyl, C3-C20 cycloalkyl, C6-C20 aryl, C7-C20 alkylaryl, or C7-C20 arylalkyl radicals, optionally containing heteroatoms belonging to groups 13-17 of the Periodic Table of the Elements; alternatively R⁵ and R⁶, or R⁸ and R⁹ form a saturated or unsaturated, 5 or 6 membered rings, providing that at least one of R⁶ or R⁷ is a linear or branched, saturated or unsaturated C1-C20 alkyl radical, optionally containing heteroatoms belonging to groups 13-17 of the Periodic Table of the Elements;

In some embodiments, R⁸ and R⁹, equal to or different from each other, are C1-C10 alkyl or C6-C20 aryl radicals; alternatively methyl radicals;

In some embodiments, X is a hydrogen atom, a halogen atom, a OR′O group, or a R group. In some embodiments, X is chlorine or a methyl radical. In some embodiments, R¹ and R² are the same and are C1-C10 alkyl radicals optionally containing one or more silicon atoms. In some embodiments, R¹ and R² are methyl radicals. In some embodiments, the R⁵—R⁶ or R⁸—R⁹ ring bears C₁-C₂₀ alkyl radicals as substituents. In some embodiments, R⁶ or R⁷ is a C₁-C₁₀-alkyl radical. In some embodiments, R³ and R⁴, equal to or different from each other, are C₁-C₁₀-alkyl radicals. In some embodiments, R³ is a methyl or ethyl radical. In some embodiments, R⁴ is a methyl, ethyl, or isopropyl radical. In some embodiments, R⁵ is a hydrogen atom or a methyl radical.

In some embodiments, R⁶ is a hydrogen atom or a methyl, ethyl, or isopropyl radical.

In some embodiments, R⁷ is a linear or branched, saturated or unsaturated C1-C20 alkyl radical, optionally containing heteroatoms belonging to groups 13-17 of the Periodic Table of the Elements; alternatively a C1-C10 alkyl radical; alternatively a methyl or ethyl radical. In some embodiments, R⁶ is different from a hydrogen atom and R⁷ is a hydrogen atom.

In some embodiments, the compound of formula (I) is wherein:

M, X, R¹, R², R⁵, R⁶, R⁸ and R⁹ are as described above;

R⁴ and R⁷ are methyl radicals; and

R³ is a linear or branched, saturated or unsaturated C1-C20 alkyl radical, optionally containing heteroatoms belonging to groups 13-17 of the Periodic Table of the Elements; alternatively R³ is a C1-C10 alkyl radical; alternatively R³ is a methyl or ethyl radical.

In some embodiments, alumoxanes used as component (2) are obtained by reacting water with an organo-aluminum compound of formula HⱼAlU₃₋ⱼ or HⱼAl₂U₆₋ⱼ, where U substituents, same or different, are hydrogen atoms, halogen atoms, C1-C20 alkyl, C3-C20 cycloalkyl, C6-C20 aryl, C7-C20-alkylaryl, or C7-C20 arylalkyl radical, optionally containing silicon or germanium atoms, providing at least one U is different from halogen, and j ranges from 0 to 1, being also a non-integer number. In some embodiments and in this reaction, the molar ratio Al/water is between about 1:1 and about 100:1. In some embodiments, the molar ratio between aluminum and the metal of the metallocene is between about 10:1 and about 20,000:1, alternatively between about 100:1 and about 5000:1.

In some embodiments, the alumoxanes are selected from the group consisting of methylalumoxane (MAO), tetra-(isobutyl)alumoxane (TIBAO), tetra-(2,4,4-trimethyl-pentyl)alumoxane (TIOAO), tetra-(2,3-dimethylbutyl)alumoxane (TDMBAO), and tetra-(2,3,3-trimethylbutyl)alumoxane(TTMBAO).

In some embodiments, the cocatalysts are as described in Patent Cooperation Treaty Publication Nos. WO 99/21899 and WO01/21674, wherein the alkyl and aryl groups have specific branched patterns. In some embodiments, aluminum compounds are as described in Patent Cooperation Treaty Publication Nos. WO 99/21899 and WO01/21674, and selected from the group consisting of tris(2,3,3 trimethyl-butyl)aluminum, tris(2,3 dimethyl-hexyl)aluminum, tris(2,3 dimethyl-butyl)aluminum, tris(2,3 dimethyl-pentyl)aluminum, tris(2,3 dimethyl-heptyl)aluminum, tris(2 methyl-3-ethyl-pentyl)aluminum, tris(2 methyl-3-ethyl-hexyl)aluminum, tris(2 methyl-3-ethyl-heptyl)aluminum, tris(2 methyl-3-propyl-hexyl)aluminum, tris(2 ethyl-3-methyl-butyl)aluminum, tris(2 ethyl-3-methyl-pentyl)aluminum, tris(2,3 diethyl-pentyl)aluminum, tris(2 propyl-3-methyl-butyl)aluminum, tris(2 isopropyl-3-methyl-butyl)aluminum, tris(2 isobutyl-3-methyl-pentyl)aluminum, tris(2,3,3 trimethyl-pentyl)aluminum, tris(2,3,3 trimethyl-hexyl)aluminum, tris(2 ethyl-3,3-dimethyl-butyl)aluminum, tris(2 ethyl-3,3-dimethyl-pentyl)aluminum, tris(2 isopropyl-3,3-dimethyl-butyl)aluminum, tris(2 trimethylsilyl-propyl)aluminum, tris(2 methyl-3-phenyl-butyl)aluminum, tris(2 ethyl-3-phenyl-butyl)aluminum, tris(2,3 dimethyl-3-phenyl-butyl)aluminum, tris(2-phenyl-propyl)aluminum, tris[2-(4-fluoro-phenyl)-propyl]aluminum, tris[2-(4-chloro-phenyl)-propyl]aluminum, tris[2-(3-isopropyl-phenyl)-propyl]aluminum, tris(2-phenyl-butyl)aluminum, tris(3 methyl-2-phenyl-butyl)aluminum, tris(2-phenyl-pentyl)aluminum, tris[2-(pentafluorophenyl)-propyl]aluminum, tris[2,2-diphenyl-ethyl]aluminum, and tris[2-phenyl-2-methyl-propyl]aluminum, the corresponding compounds wherein one of the hydrocarbyl groups is replaced with a hydrogen atom, and the corresponding compounds wherein one or two of the hydrocarbyl groups are replaced with an isobutyl group.

In some embodiments, the aluminum compounds are selected from the group consisting of trimethylaluminum (TMA), triisobutylaluminum (TIBAL), tris (2,4,4-trimethyl-pentyl)aluminum(TIOA), tris(2,3-dimethylbutyl)aluminum (TDMBA), and tris(2,3,3-trimethylbutyl)aluminum (TTMBA).

In some embodiments, the alkylmetallocene cation is prepared from compounds of formula D+E−, wherein D+ is a Brønsted acid, able to donate a proton and to react irreversibly with a substituent X of the metallocene of formula (I) and E− is a compatible anion, which is able to stabilize the active catalytic species originating from the reaction of the two compounds, and which is able to be removed by an olefinic monomer. In some embodiments, the anion E— is made from or containing one or more boron atoms. In some embodiments, the anion E− is an anion of the formula BAr₄⁽⁻⁾, wherein the substituents Ar are aryl radicals. In some embodiments, the substituents Ar are identical or different. In some embodiments, the aryl radicals are selected from the group consisting of phenyl, pentafluorophenyl, and bis(trifluoromethyl)phenyl. In some embodiments, the compound is tetrakis-pentafluorophenyl borate. In some embodiments, the compounds are as described in Patent Cooperation Treaty Publication No. WO91/02012. In some embodiments, the compounds have the formula BAr₃. In some embodiments, the compounds are as described in Patent Cooperation Treaty Publication No. WO92/00333.

In some embodiments, the alkylmetallocene cation is prepared from compounds of formula BAr₃P, wherein P is a substituted or unsubstituted pyrrol radicals. In some embodiments, these compounds are as described in Patent Cooperation Treaty Publication No. WO01/62764. In some embodiments, the cocatalyst are as described in European Patent Application No. EP-A-0 775 707 and German Patent No. DE 19917985. In some embodiments, compounds containing boron atoms are supported as described in German Patent Application Nos. DE-A-19962814 and DE-A-19962910. In some embodiments, these compounds containing boron atoms are used in a molar ratio between boron and the metal of the metallocene of between about 1:1 and about 10:1; alternatively 1:1 and 2.1; alternatively about 1:1.

In some embodiments, compounds of formula D+E− are selected from the group consisting of:

Triethylammoniumtetra(phenyl)borate,

Trimethylammoniumtetra(tolyl)borate,

Tributylammoniumtetra(tolyl)borate,

Tributylammoniumtetra(pentafluorophenyl)borate,

Tripropylammoniumtetra(dimethylphenyl)borate,

Tributylammoniumtetra(trifluoromethylphenyl)borate,

Tributylammoniumtetra(4 fluorophenyl)borate,

N,N Dimethylaniliniumtetra(phenyl)borate,

N,N Dimethylaniliniumtetrakis(pentafluorophenyl)borate,

Di(propyl)ammoniumtetrakis(pentafluorophenyl)borate,

Di(cyclohexyl)ammoniumtetrakis(pentafluorophenyl)borate,

Triphenylphosphoniumtetrakis(phenyl)borate,

Tri(methylphenyl)phosphoniumtetrakis(phenyl)borate,

Tri(dimethylphenyl)phosphoniumtetrakis(phenyl)borate,

Triphenylcarbeniumtetrakis(pentafluorophenyl)borate,

Triphenylcarbeniumtetrakis(phenyl)aluminate,

Ferroceniumtetrakis(pentafluorophenyl)borate, and

N,N Dimethylaniliniumtetrakis(pentafluorophenyl)borate.

In some embodiments, organic aluminum compounds used as compound (3) have the formula HⱼAlU₃₋ⱼ or HⱼAl₂U₆₋ⱼ. In some embodiments, the catalyst is supported on an inert carrier. In some embodiments, the metallocene compound (1), the product of the reaction thereof with the component (2), or the component (2) and then the metallocene compound (1) are deposited on an inert support. In some embodiments, the inert support is selected from the group consisting of silica, alumina, Al—Si, Al—Mg mixed oxides, magnesium halides, styrene/divinylbenzene copolymers, polyethylene, and polypropylene. In some embodiments, the supportation process is carried out in an inert solvent, at a temperature ranging from 0° C. to 100° C., alternatively from 25° C. to 90° C., alternatively at 25° C. In some embodiments, the inert solvent is a hydrocarbon. In some embodiments, the hydrocarbon is selected from the group consisting of toluene, hexane, pentane, and propane.

In some embodiments, the supports are porous organic supports functionalized with groups having active hydrogen atoms. In some embodiments, the organic support is a partially crosslinked styrene polymer. In some embodiments, the supports are as described in European Patent Application No. EP-A-0 633 272. In some embodiments, the supports are polyolefin porous prepolymers. In some embodiments, the polyolefin is polyethylene.

In some embodiments, the inert supports are porous magnesium halides. In some embodiments, the porous magnesium halides are described in Patent Cooperation Treaty Publication No. WO 95/32995.

In some embodiments, the process for the polymerization of butene-1 with ethylene and optionally a further comonomer is carried out in the liquid phase, optionally in the presence of an inert hydrocarbon solvent, that is, in slurry, or in the gas phase. In some embodiments, the hydrocarbon solvent is aromatic or aliphatic. In some embodiments, the aromatic hydrocarbon solvent is toluene. In some embodiments, the aliphatic hydrocarbon solvent is selected from the group consisting of propane, hexane, heptane, isobutane, and cyclohexane. In some embodiments, the polymerization temperature ranges from 10° C. to 200° C., alternatively from 40° to 90° C., alternatively from 50° C. to 80° C. In some embodiments, the polymerization pressure is between 0.5 and 100 bar.

It is believed that the lower the polymerization temperature, the higher are the resulting molecular weights of the polymers obtained.

In some embodiments, the polybutene component (II) consists of the butene-1 copolymer.

In some embodiments and when exiting the reactor, the butene-1 copolymer is melt mixed with up to and including 15% by weight, alternatively from 0.1 to 15% by weight, of a propylene polymer (a) selected from the group consisting of propylene homopolymers, propylene copolymers having from 0.1 to 10.0% by weight of a comonomer of formula CH₂═CHR, where R is H or a linear or branched C2-C8 alkyl, based on the weight of the propylene polymer, and combinations thereof. In some embodiments, the comonomer is ethylene.

In some embodiments, the polybutene component (II) is a composition made from or containing from 99.9% to 85.0% by weight, based on the weight of the polybutene component (II), of a butene-1 copolymer and from 0.1% to 15% by weight, based on the weight of the polybutene component (II), of a propylene polymer (a) selected from the group consisting of propylene homopolymers, propylene copolymers with from 0.1% to 10.0% by weight of a comonomer of formula CH₂═CHR, where R is H or a linear or branched C2-C8 alkyl, based on the weight of the propylene polymer. In some embodiments, the comonomer is ethylene. In some embodiments, the propylene polymer (a) has a MFR value lower than 10 g/10 min, alternatively ranging from 0.01 to 10 g/10 min., measured at 230° C. with a load of 2.16 kg according to the method ISO 1133, and a xylene soluble fraction at 25° C. equal to or lower than 10% by weight, alternatively ranging from 0.1% to 10% by weight, based on the weight of the propylene polymer (a).

In some embodiments, the polyolefin composition is further made from or containing an additive (III) selected from the group consisting of fillers, pigments, nucleating agents, extension oils, flame retardants, UV resistants, UV stabilizers, lubricants, antiblocking agents, waxes, coupling agents for fillers, and combinations thereof. In some embodiments, the flame retardant is aluminum trihydrate. In some embodiments, the UV resistant is titanium dioxide. In some embodiments, the lubricant is oleamide.

In some embodiments, the polyolefin composition is made from or containing up to and including 50% by weight, alternatively from 0.01 to 50% by weight, alternatively from 0.5 to 30% by weight, of the additive (III), wherein the amount of the additive (III) is based on the total weight of the polyolefin composition made from or containing the additive (III), the total weight being 100.

In some embodiments, the polyolefin composition is prepared by melt-mixing components (I), (II), and optionally (III) in a melt-blending equipment. In some embodiments, the melt-blending equipment is an extruder.

In some embodiments, the present disclosure provides a shaped article made from or containing the polyolefin composition. In some embodiments, the shaped article is a film or sheet.

In some embodiments, the shaped article is a film having thickness ranging from 1000 to 2000 μm, alternatively from 1200 to 1800 μm.

In some embodiments, the shaped article is a film or sheet made from or containing a layer X and a layer Y adhered to a surface of the layer X, wherein the layer X is made from or containing the polyolefin composition and the layer Y is made from or containing a plastic material selected from the group consisting of propylene homopolymers, propylene copolymers, polyethylene, polyethylene terephthalate, and combinations thereof.

In some embodiments, the layer Y is a woven or a non-woven fabric.

In some embodiments, films and sheets are obtainable by extrusion, calendering, or co-extrusion.

In some embodiments, the shaped article is film or sheet for use as single-ply roofing sheet or membrane.

In some embodiments, the shaped article is a film or sheet for use as geomembrane.

The features describing the subject matter of the present disclosure are not inextricably linked to each other. In some embodiments, a level of a feature does not involve the same level of the remaining features. Various combinations of parametric ranges or features are encompassed in the present disclosure, even if not explicitly described.

### EXAMPLES

The following examples are illustrative and not intended to limit the scope of the disclosure in any manner whatsoever.

### Characterization Methods

The following methods are used to determine the properties indicated in the description, claims and examples.

Melt Flow Rate: Determined according to the method ISO 1133 (230° C., 2.16 kg).

Solubility in xylene at 25° C.: 2.5 g of polymer sample and 250 ml of xylene were introduced into a glass flask equipped with a refrigerator and a magnetic stirrer. The temperature was raised in 30 minutes up to 135° C. The resulting clear solution was kept under reflux and stirred for further 30 minutes. The solution was cooled in two stages. In the first stage, the temperature was lowered to 100° C. in air for 10 to 15 minute under stirring. In the second stage, the flask was transferred to a thermostatically-controlled water bath at 25° C. for 30 minutes. The temperature was lowered to 25° C. without stirring during the first 20 minutes and maintained at 25° C. with stirring for the last 10 minutes. The formed solid was filtered on quick filtering paper (for example, Whatman filtering paper grade 4 or 541). 100 ml of the filtered solution (S1) were poured into a pre-weighed aluminum container, which was heated to 140° C. on a heating plate under nitrogen flow, thereby removing the solvent by evaporation. The container was then kept in an oven at 80° C. under vacuum until constant weight was reached. The amount of polymer soluble in xylene at 25° C. was then calculated. XS(tot) and XS_{A} values were experimentally determined. The fraction of component (B) soluble in xylene at 25° C. (XS_{B}) was calculated from the formula:

$$XS = W ( A ) \times ( {XS}_{A} ) + W ( B ) \times ( {XS}_{B} )$$

wherein W(A) and W(B) are the relative amounts of components (A) and (B), respectively, and W(A)+W(B)=1.

Intrinsic viscosity of the xylene soluble fraction: to calculate the value of the intrinsic viscosity IV, the flow time of a polymer solution was compared with the flow time of the solvent tetrahydronaphthalene (THN). A glass capillary viscometer of Ubbelohde type was used. The oven temperature was adjusted to 135° C. Before starting the measurement of the solvent flow time 10, the temperature was stable (135°±0.2° C.). Sample meniscus detection for the viscometer was performed by a photoelectric device.

Sample preparation: 100 ml of the filtered solution (S1) were poured into a beaker and 200 ml of acetone were added under vigorous stirring. Precipitation of insoluble fraction was complete as evidenced by a clear solid-solution separation. The suspension was filtered on a weighed metallic screen (200 mesh). The beaker was rinsed. The precipitate was washed with acetone, thereby removing the o-xylene. The precipitate was dried in a vacuum oven at 70° C. until a constant weight was reached. 0.05 g of precipitate were dissolved in 50 ml of tetrahydronaphthalene (THN) at a temperature of 135° C. The efflux time/of the sample solution was measured and converted into a value of intrinsic viscosity [η] using Huggins' equation (Huggins, M. L., J. Am. Chem. Soc. 1942, 64, 11, 2716-2718) and the following data:
concentration (g/dl) of the sample;
the density of the solvent at a temperature of 135° C.;
the flow time to of the solvent at a temperature of 135° C. on the same viscometer.
   A single polymer solution was used to determine [η].

Comonomer content: ¹³C NMR spectra are acquired on a Bruker AV-600 spectrometer equipped with cryoprobe, operating in the Fourier transform mode at 120° C. The samples were dissolved in 1,1,2,2-tetrachloroethane-d2 at 120° C. with an 8% wt/v concentration. Each spectrum was acquired with a 90° pulse, and 15 seconds of delay between pulses and CPD, thereby removing 1H-13C coupling. The spectrometer was operated at 160.91 MHz. The peak of the Sδδ carbon (nomenclature according to “Monomer Sequence Distribution in Ethylene-Propylene Rubber Measured by 13C NMR. 3. Use of Reaction Probability Mode” C. J. Carman, R. A. Harrington and C. E. Wilkes, Macromolecules, 1977, 10, 536) was used as an internal standard at 29.9 ppm. 512 transients were stored in 32K data points using a spectral window of 9000 Hz.

Propylene copolymers: The assignments of the spectra, the evaluation of triad distribution and the composition were made according to Kakugo (“Carbon-13 NMR determination of monomer sequence distribution in ethylene-propylene copolymers prepared with δ-titanium trichloride-diethylaluminum chloride” M. Kakugo, Y. Naito, K. Mizunuma and T. Miyatake, Macromolecules, 1982, 15, 1150) using the following equations:

$$PPP = 100 {T}_{ββ} / S$$

$$PPE = 100 {T}_{βδ} / S$$

$$EPE = 100 {T}_{δδ} / S$$

$$PEP = 100 {S}_{ββ} / S$$

$$PEE = 100 {S}_{β δ} / S$$

$$EEE = 100 ( 0.25 {S}_{γ δ} + 0.5 {S}_{δδ} ) / S$$

$$S = {T}_{ββ} + {T}_{βδ} + {T}_{δδ} + {S}_{ββ} + {S}_{βδ} + 0.25 {S}_{γ δ} + 0.5 {S}_{δδ}$$

The molar content of ethylene and propylene was calculated from triads using the following equations:

$$[ E ] mol = EEE + PEE + PEP$$

$$[ P ] mol = PPP + PPE + EPE$$

The weight percentage of ethylene content (E % wt) was calculated using the following equation:

$$E \% wt = \frac{[ E ] mol \times MWE}{( [ E ] mol \times MWE ) + ( [ P ] mol \times MWP )} \times 100$$

wherein
[P] mol=the molar percentage of propylene content;
MWE=molecular weights of ethylene
MWP=molecular weight of propylene.
The total ethylene content C2(tot) and the ethylene content of component (A), C2(A) were measured. The ethylene content of component (B), C2(B), was calculated using the formula:

$$C 2 ( tot ) = W ( A ) \times C 2 ( A ) + W ( B ) \times C 2 ( B )$$

wherein W(A) and W(B) are the relative amounts of components (A) and (B) (W(A)+W(B)=1).

Butene-1 copolymers: The assignments of the spectra, the evaluation of triad distribution and the composition were made according to Kakugo [M. Kakugo, Y. Naito, K. Mizunuma and T. Miyatake, Macromolecules, 16, 4, 1160 (1982)] and Randall [J. C. Randall, Macromol. Chem Phys., C30, 211 (1989)] using the following:

$$BBB = 100 {T}_{ββ} / S$$

$$BBE = 100 {T}_{βδ} / S$$

$$EBE = 100 {P}_{δδ} / S$$

$$BEB = 100 {S}_{ββ} / S$$

$$BEE = 100 {S}_{αδ} / S$$

$$EEE = 100 ( 0.25 {S}_{γ δ} + 0.5 {S}_{δδ} ) / S$$

$$S = {T}_{ββ} + {T}_{βδ} + {P}_{δδ} + {S}_{ββ} + {S}_{αδ} + 0.25 {S}_{γ δ} + 0.5 {S}_{δδ}$$

The total amount of 1-butene and ethylene as molar percent was calculated from triad using the following relations:

$$[ E ] = EEE + BEE + BEB$$

$$[ B ] = BBB + BBE + EBE$$

The weight percentage of ethylene content (E % wt) was calculated using the following equation:

$$E \% wt = \frac{[ E ] mol \times MWE}{( [ E ] mol \times MWE ) + ( [ B ] mol \times MWB )} \times 100$$

wherein
[B] mol=the molar percentage of 1-butene content;
MWE=molecular weights of ethylene
MWB=molecular weight of 1-butene.

Molecular weight distribution: MWD was measured by way of Gel Permeation Chromatography in 1,2,4-trichlorobenzene (TCB). Molecular weight parameters (M̅ₙ, M̅_{w}, M̅_{z}) and molecular weight distributions for the samples were measured using a GPC-IR apparatus by PolymerChar, which was equipped with a column set of four PLgel Olexis mixed-bed (Polymer Laboratories) and an IR5 infrared detector (PolymerChar). The dimensions of the columns were 300×7.5 mm with the particle size 13 μm. The mobile phase flow rate was kept at 1.0 ml/min. The measurements were carried out at 150° C. Solution concentrations were 2.0 mg/ml (at 150° C.). 0.3 g/l of 2,6-diterbutyl-p-cresol were added, thereby preventing degradation. For GPC calculation, a universal calibration curve was obtained using 12 polystyrene (PS) standard samples supplied by PolymerChar (peak molecular weights ranging from 266 to 1220000). A third order polynomial fit was used to interpolate the experimental data and obtain the calibration curve. Data acquisition and processing were done using Empower 3 (Waters). The Mark-Houwink relationship was used to determine the molecular weight distribution and the average molecular weights. For butene/ethylene copolymers, the composition of each sample was assumed constant in the range of molecular weight and the K value of the Mark-Houwink relationship was calculated using a linear combination:

$${K}_{EB} = {x}_{E} {K}_{PE} + {x}_{B} {K}_{PB}$$

where K^{EB} was the constant of the copolymer, K_{PE} (4.06×10⁻⁴, dl/g) and K_{PB} (1.78×10⁻⁴ dl/g) were the constants of polyethylene (PE) and PB, xE and xB were the ethylene and the butene-1 weight relative amounts, with xE+xB=1. The Mark-Houwink exponents α=0.725 was used for the butene/ethylene copolymers independently of composition. For PS K_{PS}=1.21×10⁻⁴ dl/g and α=0.706 were used.

Thermal Properties of butene-1 copolymers: the melting points of the butene-1 polymers (TmII) was measured by Differential Scanning calorimetry (DSC) on a Perkin Elmer DSC-7 instrument. A weighed sample (5-6 mg) was sealed into aluminum pans and heated at 180° C. with a scanning speed corresponding to 10° C./minute. The sample was kept at 180° C. for 5 minutes, thereby melting the crystallites. Successively, after cooling to −20° C. with a scanning speed corresponding to 10° C./minute, the peak temperature was recorded as crystallization temperature (Tc). After standing 5 minutes at −20° C., the sample was heated for a second time at 200° C. with a scanning speed corresponding to 10° C./min. In this second heating run, the peak temperature, when detected, was taken as the melting temperature of the crystalline form II (TmII) and the area as global melting enthalpy (ΔHfII). The melting enthalpy, after 10 days, was measured on the same instrument. A weighed sample (5-10 mg) was sealed into aluminum pans and heated at 200° C. with a scanning speed corresponding to 20° C./minute. The sample was kept at 200° C. for 5 minutes, thereby melting the crystallites. The sample was then stored for 10 days at 25° C. temperature. After 10 days, the sample was subjected to DSC. The sample was cooled to −20° C., and then heated at 200° C. with a scanning speed corresponding to 10° C./min. In this heating run, the peak temperature is taken as the melting temperature (Tm) and the area as global melting enthalpy after 10 days (ΔHf).

Flexural modulus: Determined according to the method ISO 178:2019 on injection molded test specimens (80×10×4 mm) obtained according to the method ISO 1873-2:2007 for component (I) or on compression molded specimens for component (II).

Tensile Modulus: determined according to the method ISO 527-3 on 1 mm-thick extruded specimens. Specimens type 2, Crosshead speed: 1 mm/min.

Tensile stress and elongation at break: determined according to the method ISO 527-3 on 1 mm-thick extruded specimens. Specimens type: 5, Crosshead speed: 500 mm/min.

Tear resistance: Determined according to the method ASTM D 1004 on 1 mm-thick extruded specimens. Crosshead speed: 51 mm/min; V-shaped die cut specimen.

Shore A and D values: Determined according to the method ISO 868 (15 sec) on 1 mm-thick extruded specimens or on compression molded specimens.

Compression set: measured according to the method ASTM D395 at 23° C. and 25% deformation on compression molded specimens.

Preparation of extruded specimens: The polymer, in the form of granules, was fed via feed hoppers into a Leonard extruder (mono-screw extruder, 40 mm in diameter and 27 L/D in length), wherein the polymer was melted (melt temperature 230° C.), compressed, mixed, and metered out at a throughput rate of 10 Kg/h with a metering pump (15 cc/rpm). The molten polymer left the flat die (width 200 mm, die lip at 0.8-0.9 mm) and was instantly cooled through a vertical three-rolls calender, having roll-temperature of 60° C. 1 mm-thick extruded sheets were obtained.

Preparation of compression molded specimens: 4 mm thick test specimens were prepared by compression molding according to the ISO norm 8986-2:2009. PB-1 specimens were tested after 10 days of aging at 25° C. and atmospheric pressure.

### Comparative Example CE1 and Examples CE2-CE4

Preparation of the thermoplastic polyolefin (I): The polymerization was carried out in two gas phase reactors, connected in series and equipped with devices to transfer the product from the first reactor to the second reactor.

For the polymerization a Ziegler-Natta catalyst system is used comprising:
a titanium-containing solid catalyst component prepared as described in European Patent Application No. EP395083, Example 3, according to which di-isobutyl phthalate was used as internal electron donor compound;
triethylaluminum (TEAL) as co-catalyst; and
dicyclopentyl dimethoxy silane (DCPMS) as external electron donor.

The solid catalyst component was contacted with TEAL and DCPMS in a pre-contacting vessel, with a weight ratio of TEAL to the solid catalyst component of 4-5. The weight ratio TEAL/DCPMS was 5.

The catalyst system was then subjected to pre-polymerization by suspending the catalyst system in liquid propylene at 20° C. for about 30-32 minutes before introducing the catalyst system into the first polymerization reactor.

Propylene copolymer (A) was produced into the first gas-phase reactor by feeding, in a continuous and constant flow, the pre-polymerized catalyst system, hydrogen (used as molecular weight regulator), propylene, and ethylene, in gaseous phase.

The propylene copolymer (A) coming from the first reactor was discharged in a continuous flow and, after having been purged of unreacted monomers, was introduced, in a continuous flow, into the second gas-phase reactor, together with quantitatively constant flows of fresh hydrogen and ethylene, in the gas state.

In the second reactor, the propylene copolymer (B) was produced.

Polymerization conditions, molar ratio of the reactants, and composition of the copolymers obtained are shown in Table 1.

TABLE 1
polymerization conditions.

| | | |
|---|---|---|
| Temperature | ° C. | 55 |

GPR1

| | | |
|---|---|---|
| Pressure | barg | 16 |
| H₂/C₃- | mol. | 0.13 |
| C₂-/(C₂- + C₃-) | mol | 0.024 |
| Split matrix | wt % | 21 |
| Xylene solubles of A (XS_{A}) | wt % | 8 |
| MFR of A (MFR_{A}) | g/10 min. | 35 |
| C₂- content of A | wt % | 3.3 |

GPR2

| | | |
|---|---|---|
| Pressure | barg | 16 |
| H₂/C₂- | mol. | 0.07 |
| C₂-/(C₂- + C₃-) | mol. | 0.17 |
| Split | wt % | 79 |
| C₂- content of B⁽*⁾ | wt % | 28 |
| C₂- content of (A + B) | wt % | 23.5 |
| Xylene solubles of (A + B) (XS) | wt % | 74 |
| Intrinsic viscosity of (A + B) (XSIV) | dl/g | 3.3 |
| MFR of (A + B) | g/10 min. | 0.44 |
| Flexural modulus | MPa | 55 |

Notes:
C₂- = ethylene in gas phase (IR); C₃- = propylene in gas phase (IR); split = amount of polymer produced in the concerned reactor.
⁽*⁾Calculated values.

The polymer particles, exiting the second reactor, were subjected to a steam treatment, thereby removing the unreacted monomers and volatile compounds, and then dried.

The resulting polyolefin composition was mixed with additives in a twin screw extruder Berstorff ZE 25 (length/diameter ratio of screws of 34) and extruded under nitrogen atmosphere in the following conditions:

Rotation speed: 250 rpm;

Extruder output: 15 kg/hour;

Melt temperature: 245° C.

The additives added to the polyolefin composition were:
0.05% by weight of Irganox® 1010;
0.1% by weight of Irgafos® 168; and
0.05% by weight of calcium stearate.

wherein the amounts of additives are based on the total weight of the polyolefin composition containing the additives.

Irganox® 1010 was 2,2-bis[3-[,5-bis(1, 1-dimethylethyl)-4-hydroxyphenyl]-1-oxopropoxy]methyl]-1,3-propanediyl-3,5-bis(1,1-dimethylethyl)-4-hydroxybenzene-propanoate; Irgafos® 168 was tris(2,4-di-tert.-butylphenyl) phosphite.

A polybutene component (II) made from or containing 90% by weight, based on the weight of (II), of a copolymer of butene-1 with ethylene, having a Mw/Mn of 2.2, and 10% by weight, based on the weight of (II), of a propylene-ethylene copolymer having 3.2% by weight of ethylene-derived units, based on the weight of the propylene component, was used. The polybutene component (II) had the following properties:
an ethylene content of 7.9% by weight;
a flexural modulus of less than 10 MPa (ISO 178:2019, measured on compression molded specimens);
a shore A value of 60 (ISO 868, measured on compression molded specimens); and
a compression set of 30% (ASTM D395, at 23° C., 25% deformation, measured on compression molded specimens).

The butene-1 copolymer had no TmII and had an enthalpy, after 10 days of aging, ΔHf of less than 15 J/g.

The butene-1 copolymer was prepared using a metallocene-based catalyst system C2A1 as described in Patent Cooperation Treaty Publication No. WO2010/069775. The polymerization was carried out in two stirred reactors, connected in series, wherein butene-1 was the liquid medium. The catalyst system C2A1 and the polymerization were carried out in continuous at a temperature of 70° C. and at a pressure of 20 barg in both reactors. The butene-1 copolymer was recovered as a melt from the solution, compounded with the propylene copolymer, and cut in pellets. The polymerization conditions are reported in Table 2.

TABLE 2
Polymerization conditions of butene-1 copolymer

| | | Reactor 1 | Reactor 2 |
|---|---|---|---|
| Residence time | min. | 190 | 122 |
| Catalyst feed | kg/h | 2.5 | 1.5 |
| C4-feed (total) | kg/h | 13500 | 6200 |
| C2-feed | kg/h | 394 | 250 |
| H2 feed | g/h | 40 | 23 |
| H2 bulk conc. | ppm | 160 | 160 |
| Solution density | kg/m³ | 587 | 600 |
| Polymer concentration | wt. % | 25 | 28 |
| Split between reactors | | 60 | 40 |

In a co-rotating twin screw extruder Berstorff ZE25 the thermoplastic polyolefin (I) was melt-blended with the polybutene component (II). The blend was extruded under nitrogen atmosphere in the following conditions: Rotation speed of 250 rpm; Extruder output of 15 kg/hour; Melt temperature of 270° C. The mechanical properties of the compositions are reported in Table 3.

TABLE 3
Compositions and mechanical properties

| | | CE1 | E2 | E3 | E4 |
|---|---|---|---|---|---|
| HECO (I) | wt % | 100 | 90 | 85 | 80 |
| PB-1 (II) | wt % | — | 10 | 15 | 20 |
| Tensile Modulus MD | MPa | 65 | 50 | 45 | 30 |
| Stress at break MD | MPa | 14.4 | 13.6 | 16.5 | 15.8 |
| Elongation at break MD | % | 640 | 688 | 800 | 793 |
| Tensile modulus TD | MPa | 40 | 43 | 30 | 25 |
| Stress at break TD | MPa | 14.2 | 14.2 | 16.0 | 16.4 |
| Elongation at break TD | % | 690 | 726 | 920 | 900 |
| Tear Resistance MD | g | 54 | 53 | 58 | 50 |
| Tear resistance TD | g | 55 | 59 | 59 | 49 |
| Shore A | | 84 | 83 | 79 | 80 |
| Shore D | | 26 | 24 | 23 | 22 |

What is claimed is:

1. A polyolefin composition comprising:
(I) 75-95% by weight of a thermoplastic polyolefin comprising:
(A) 18-30% by weight of a copolymer of propylene with from 1.0 to 6.0% by weight of a comonomer of formula CH₂═CHR, where R is H or a linear or branched C2-C8 alkyl, based on the weight of (A), and having a melt flow rate (MFR(A)), measured according to ISO 1133 (230° C., 2.16 kg), ranging from 30 to 60 g/10 min; and
(B) 70-82% by weight of a copolymer of propylene with from 20 to 35% by weight of a comonomer of formula CH₂═CHR, and optionally a diene, where R is H or a linear or branched C2-C8 alkyl, based on the weight of (B),
wherein the thermoplastic polyolefin has
i) an amount of fraction soluble in xylene at 25° C. (XS(I)) equal to or greater than 70% by weight, based on the total weight of (A)+(B); and
ii) a melt flow rate (MFR(I)), measured according to ISO 1133 (230° C., 2.16 kg) from 0.2 to 15.0 g/10 min, and
wherein the amounts of (A) and (B) are based on the total weight of (A)+(B); and
(II) 5-25% by weight of a polybutene component,
having a flexural modulus equal to or lower than 60 MPa, measured according to the method ISO 178:2019 and
comprising a copolymer of butene-1 with ethylene and optionally a comonomer of formula CH₂═CHR¹, where R¹ is methyl or a linear or branched C3-C8 alkyl,
wherein the copolymer of butene-1 having
iii) up to and including 20% by weight of units deriving from ethylene and optionally the comonomer, based on the weight of (II); and
ii) a molecular weight distribution Mw/Mn equal to or lower than 3;
wherein the amounts of (I) and (II) are based on the total weight of (I)+(II).

2. The polyolefin composition of claim 1 comprising from 80 to 90% by weight of the thermoplastic polyolefin (I) and from 10 to 20% by weight of the polybutene component (II), wherein the amounts of (I) and (II) are based on the total weight of (I)+(II).

3. The polyolefin composition of claim 1, wherein the comonomers CH₂═CHR of components (A) and (B) of the thermoplastic polyolefin (I) are independently selected from the group consisting of ethylene, butene-1, hexene-1, 4-methy-pentene-1, octene-1 and combinations thereof.

4. The polyolefin composition according to claim 1, wherein the thermoplastic polyolefin (I) has an amount of fraction soluble in xylene at 25° C. (XS(I)) ranging from 70 to 90% by weight, based on the weight of the thermoplastic polyolefin (I).

5. The polyolefin composition according to claim 1, wherein the fraction soluble in xylene at 25° C. of the thermoplastic polyolefin (I) has an intrinsic viscosity XSIV(I) ranging from 2.5 to 4.5 dl/g.

6. The polyolefin composition according to claim 1, wherein the thermoplastic polyolefin (I) has a melt flow rate MFR(I), measured according to ISO 1133 (230° C., 2.16 kg), ranging from 0.2 to 5.0 g/10 min.

7. The polyolefin composition according to claim 1, wherein the propylene copolymer (A) has a melt flow rate (MFR(A)), measured according to ISO 1133 (230° C., 2.16 kg), ranging from 35 to 50 g/10 min.

8. The polyolefin composition according to claim 1, wherein the copolymer of butene-1 of the polybutene component (II) is a copolymer of butene-1 and ethylene having from 5 to 10% by weight of units deriving from ethylene, based on the weight of polybutene component (II).

9. The polyolefin composition according to claim 1, wherein the polybutene component (II) has a flexural modulus equal to or lower than 60 MPa, measured according to the method ISO 178:2019.

10. The polyolefin composition according to claim 1, wherein the polybutene component (II) has at least one of the following properties:
a shore A value equal to or lower than 90, measured according to the method ISO 868 on compression-molded specimens; or
a compression set equal to or lower than 50%, measured on compression-molded specimens according to the method ASTM D395 at 23° C. and 25% deformation.

11. A shaped article comprising the polyolefin composition according to claim 1.

12. The shaped article according to claim 11, wherein the article is a film or sheet.

13. The shaped article according to claim 12, comprising a layer X and a layer Y adhered to a surface of the layer X, wherein the layer X comprises the polyolefin composition and the layer Y comprises a plastic material selected from the group consisting of propylene homopolymers, propylene copolymers, polyethylene, polyethylene terephthalate, and combinations thereof.

14. The shaped article according to claim 12, wherein the film or sheet is a layer of a single-ply roofing sheet or membrane.

15. The shaped article according to claim 12, wherein the film or sheet is a layer of a geomembrane.
